(19) United States
(12) Patent Application Publication
(10) Pub. No.: US 2021/0241202 A1
(43) Pub. Date: Aug. 5, 2021

(54) TRACKING OF EQUIPMENT UTILIZATION VIA DISTRIBUTED LEDGER

(71) Applicants: Tomas Tichy, Cleveland, OH (US); Michael Cromheecke, Grafton, WI (US)

(72) Inventors: Tomas Tichy, Cleveland, OH (US); Michael Cromheecke, Grafton, WI (US)

(21) Appl. No.: 17/164,178

(22) Filed: Feb. 1, 2021

Related U.S. Application Data
(60) Provisional application No. 62/968,319, filed on Jan. 31, 2020.
(60) Provisional application No. 62/968,347, filed on Jan. 31, 2020.
(60) Provisional application No. 62/968,371, filed on Jan. 31, 2020.
(60) Provisional application No. 62/969,297, filed on Feb. 3, 2020.

(51) Int. Cl. G06Q 10/06; G06Q 20/40; G06Q 20/36; H04L 9/06

(52) U.S. Cl. CPC G06Q 10/06393; G06Q 20/401; H04L 2209/38; H04L 9/0643; G06Q 20/36

(57) ABSTRACT

Systems and methods are provided for monitoring a client device. An agent is configured to monitor a dynamic, user-defined set of key performance indicators by periodically polling the client device and generate messages including an aggregate value for a key performance indicator over a predefined period of time, and an identifier associated with the client device. A transaction manager accepts messages from the agent, provides a confirmation message to the agent indicating receipt of each message, and records the messages in a distributed ledger.

### RELATED APPLICATIONS

This application claims priority from each of U.S. Provisional Application No. 62/968,319, filed 31 Jan. 2020, U.S. Provisional Application No. 62/968,347, filed 31 Jan. 2020, U.S. Provisional Application No. 62/968,371, filed 31 Jan. 2020, and U.S. Provisional Application No. 62/969,297, filed 3 Feb. 2020. The subject matter of each of these applications is incorporated herein by reference in its entirety.

### TECHNICAL FIELD

This invention relates to monitoring of commercial and industrial equipment, and more particularly, to tracking of equipment utilization via a distributed ledger.

### BACKGROUND

A critical requirement for deploying “machine as a service” business models in many market segments is the reliability of the data collection and communication mechanism. For industrial and commercial equipment, it is critical that slow or failed communication does not cause downtime for users. Similarly, the machine as a service model needs to account for situations in which the machine cannot be easily monitored by a remote platform, for example, when the machine is not communicating with the server. For example, a machine user may be required to pay the original equipment manufacturer for machine availability in his facility even when a machine is powered off for an off-shift. Even where this is not the arrangement, some machine users may be tempted to disrupt the communication channel to skew the data collection on the performance of the machine.

### SUMMARY OF THE INVENTION

In accordance with a first example, a system includes an agent configured to monitor a dynamic, user-defined set of key performance indicators by periodically polling a client device and generate messages including an aggregate value for a key performance indicator over a predefined period of time, and an identifier associated with the client device. A transaction manager accepts messages from the agent, provides a confirmation message to the agent indicating receipt of each message, and records the messages in a distributed ledger.

In accordance with another example, a method includes receiving a value for a key performance indicator, representing an interval of time associated with a client device, at an agent associated with the client device and recording the value for the key performance indicator as a record comprising a time slot index representing the interval of time and the value for the key performance indicator. A message, comprising the value for the key performance indicator, the time slot index, and an identifier associated with the client device, is to a transaction manager and recorded on a distributed ledger.

In accordance with yet another example, a method includes receiving a value for a key performance indicator, representing an interval of time associated with a client device, at an agent associated with the client device and recording the value for the key performance indicator as a record comprising a current time slot index representing the interval of time and the value for the key performance indicator. The current time slot index is compared to a stored time slot index representing a time slot for a last value for the key performance indicator received from the client device. A message, comprising the value for the key performance indicator, the time slot index, an identifier associated with the client device, and an indication that the key performance indicator represents an actual value, is sent to a transaction manager if the current time slot index has a value greater than the stored time slot index by one.

A set of messages, each comprising an average value for the key performance indicator over a series of time slots that includes the current time slot index, a time slot index representing one of the series of time slots, an identifier associated with the client device, and an indication that the key performance indicator represents an average value, is sent to the transaction manager if the current time slot index has a value greater than the stored time slot index by more than one. The stored time slot index with the current time slot index, and the message is recorded on a distributed ledger.

### BRIEF DESCRIPTION OF THE DRAWINGS

FIG. 1 illustrates one example of a system for managing a client device;

FIG. 2 illustrates one example of a system for managing a plurality of client devices

FIG. 3 illustrates one example of a method for monitoring the performance of a client device;

FIG. 4 illustrates another example of a method 300 for monitoring the performance of a client device; and

FIG. 5 is a schematic block diagram illustrating an exemplary system of hardware components capable of implementing examples of the systems and methods disclosed herein.

### DETAILED DESCRIPTION

As used herein, a “client device” is any item of commercial or industrial equipment that has been offered for the use of a customer pursuant to a contract based on the performance or use of the equipment.

As used herein, a “key performance indicator” is a metric representing the performance or use of a client device. The key performance indicator for a given client device is generally selected by the owner of the client device to represent terms of the contract between the owner of the client device and the user of the client device.

As used herein, a “distributed ledger” is a data and execution system that is consensually shared and synchronized across a network of multiple sites, institutions, or geographies, referred to as nodes, and accessible by multiple people. The participant at each node of the network can access the recordings shared across that network and can own an identical copy of it. Any changes or additions made to the ledger are reflected and copied to all participants in a matter of seconds or minutes.

As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

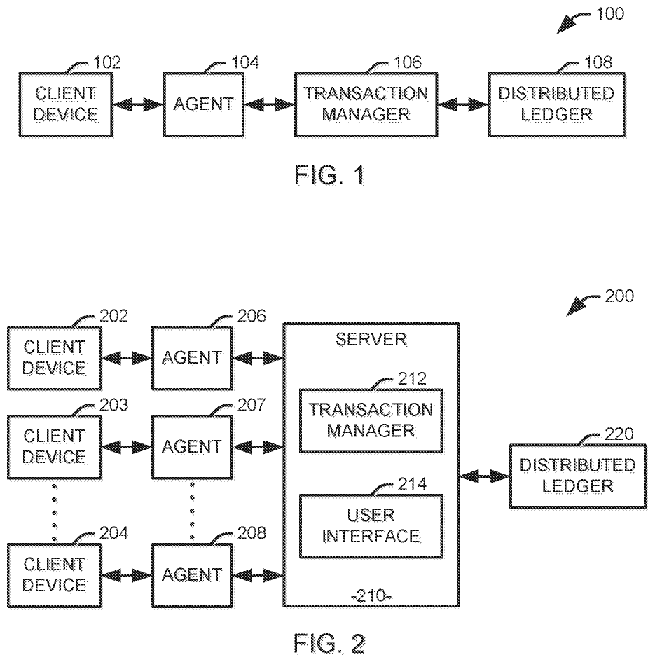

FIG. 1 illustrates one example of a system 100 for managing a client device 102. The system includes an agent 104 configured to monitor a dynamic, user-defined set of key performance indicators by periodically polling the client device 102. Key performance indicators can include, for example, a time for which the client device 102 is operated, a time for which the client device is available to be operated, a productivity of the device, measured, for example, as a quantity of a product produced or a number of a specific task performed. The agent 104 can generate messages for a transaction manager 106 that supervises the agent, including an aggregate value for at least one of the set of key-performance indicators over a predefined period of time and an identifier associated with the client device 102. In some examples, the agent 104 also stores the message locally. Each of the message and the locally stored record can include a hash value generated by the agent that can be used at the transaction manager to verify that the contents of the message or record have not been modified. In general, the message is sent from the agent to the transaction manager 106 via a network connection, but other methods, including the use of an external portable memory device or a display or printout of a visual or alphanumeric code can be used to transfer the message from the agent 104 to a device connected to a communications network.

The transaction manager 106 accepts messages from the agent 104 and provides a confirmation message to the agent indicating receipt of each message. Where the agent 104 stores the messages locally, the agent may delete a record once a corresponding confirmation is received. To ensure that the agent 104 has sufficient storage to withstand interruptions in communication with the transaction manager 106, the agent can generate messages with reduced fidelity when a storage limit is reached. In one example, the agent 106 generates messages periodically at a first interval until a predetermined storage limit is achieved, and generates messages periodically at a second interval after the predetermined storage limit is achieved. To further conserve space, the agent 106 generating respective representative values of the key performance indicator for messages generated at the first interval and replace stored records with the representative value to provide values for the key performance indicator for time periods equal to the second interval.

The transaction manager 106 then records the message in a distributed ledger 108. It will be appreciated that the distributed ledger 108 can be implemented using blockchain technology. In one example, the contract for the client device 102 is maintained on the distributed ledger 108 as a smart contract based on one or more of the key performance indicators, and the contract can be settled using an electronic funds transfer or cryptocurrency transfer from a user of the client device to an owner of the client device having an amount based on the value for the key performance indicator in response to recordation of the message containing the key performance indicators at the distributed ledger.

In one example, the key performance indicators are continuous parameters that do not decrease, and the agent 104 records the key performance indicator from the client machine as a record comprising a time slot index, representing an interval of time, and a value for the key performance indicator associated with the client device during that time interval. The record representing each time slot index is provided from the agent 104 to the transaction manager 106 as a message, and the transaction manager 106 utilizes the same indexing arrangement in recording the event at the distributed ledger 108. In one example, wherein the transaction manager 106, in response to the passage of a threshold period of time in which no communication is received from the agent, can generate records in the distributed ledger for each time slot for which no data was received indicating that the client device 102 is offline. Once data for one or more of these time slots is received from the agent 104, a smart contract can search the distributed ledger 108 for other entries for the time slot indices associated with the new messages and replace any records in the distributed ledger for these time slot indices for which the client device 102 was indicated as being offline.

In another example, the agent 104 can store a record representing a most recent time slot index in a portion of a memory that is not writable by an end user of the client device 102. This stored record can be used to account for time in which the agent 104 may have been offline and missed activity at the client device. To this end, the agent 104 can compares a record associated with a current state of the client device 102 to the stored record to determine if the client device has been active while the agent was inactive. Where there has been unmonitored activity, the agent 104 can generate an average value for the key performance indicator across the unmonitored time slots and generate a message for each unmonitored time slot that includes an index for the time slot, the average value, and an indication that the values for the key performance indicator are averaged values.

FIG. 2 illustrates one example of a system 200 for managing a plurality of client devices. In the illustrated system 200, each client device 202-204 is maintained as part of a machine as a service (MaaS) system, in which a customer pays for the use of a given client device (e.g., 202) according to a set of one or more key performance indicators associated with the client device. For example, where the client devices 202-204 are industrial machinery, the key performance indicators can include a length of time in which the client device is operated, a length of time for which the client device is operational, a length of time for which the client device is not operational, a quantity of a product produced at the client device, or similar measures of the availability and productivity of the client device. It will be appreciated that the key performance indicators can vary with the function of the client device and the agreement between the customer and the owner of the client devices 202-204.

Each client device 202-204 has an associated agent 206-208 that monitors the key performance indicators at the device. The agent 206-208 can be installed as software or firmware on hardware associated with each client device 202-204 or can be implemented as a separate component that is operatively connected to the client device. Where the agent 206-208 is installed as a separate component, the agent can include a processor, one or more local memories, and a network interface or transceiver for communicating with a remote server 210. The agent 206-208 can perform a number of functions including controlling access to the client device 202-204, storing data received from client device, and sending messages to the remote server 210 representing the data received from the client device or acknowledgement of commands received from the server 210. In one example, the agent 206-208 encrypts both stored data and messages transmitted to the server 210. In one implementation, the messages sent from the agent 206-208 can be coupled with a hash value to allow the server 210, for example, at a transaction manager 212, to verify that the contents of the message have not been altered.

It will be appreciated that communication with the server 210 can be intermittent or periodic and the agent 206-208 can queue messages intended for the server 210 until communication with the server is possible. To ensure that the memory available at the agent 206-208 is adequate for this task, the fidelity of the data storage, represented by the size of the interval of time represented by a given record and set of key performance indicators, can be varied according to the needs of the system. In one example, a fixed data structure stores the necessary data for a finite number of “machine periods”. Once communication with the server 210 has been interrupted long enough to exceed the capacity of the data structure prior to successful transmission of the data, the agent 206-208 begins to reduce the fidelity of the data starting with the oldest records. By increasing, for example, doubling, the time basis of the original “machine period” the data can be preserved with a lower fidelity. The data will still be able to provide the average throughput over a period of time, but that time basis will be greater than the original “machine period” and will therefore take up less local storage space. This ensures that the average throughput and overall runtime of the machine is documented even as the time basis grows increasingly larger.

The server 210 can include the transaction manager 212 and a user interface 214. It will be appreciated that the server 210 can be implanted on one or more dedicated hardware servers or as a virtual or cloud arrangement in which the server is implemented using computing resources from a shared group of hardware servers. In the illustrated implementation, the server 210 is implemented as a cloud server. The transaction manager 212 receives and decrypts messages from the agents 206-208, for example, containing values for key performance indicators for their corresponding client devices 202-204 and provides confirmation messages for each message, referencing a globally unique identifier associated with each message, and any commands provided via the user interface 214 to the agents. The transaction manager 212 can also interact with a distributed ledger 220 to record the received messages from the agents 206-208 and any commands sent to the agents.

For example, the commands could include a command to disable a client device 202-204 immediately, enable a client device, or disable the client device upon reaching a defined value for a key performance indicator. For example, a user could provide a command for the agent 206-208 to allow the client device to operate until the key performance value reaches a selected value (e.g., a number of units of a product produced). This allows the client device 202-204 to continue operating for a prolonged period of time without violating contractual limitations even when the agent 206-208 cannot communicate with the transaction manager 212. It will be appreciated that confirmation messages and commands from the transaction manager 212 for a given agent 206-208 can be queued at the server 210 until the agent sends a message to the server.

The agent 206-208 records a value for the key performance indicators at each of a plurality of discrete time slots. In one example, each time slot represents one hour. In general, each message provided to the transaction manager can represent one time slot. In one example, each message can include the globally unique identifier for the message, a time slot index representing a current time slot, for example, as a thirty-two bit integer, a type of the message, and an array of key performance indicators. The time slot index can be sequential, such that the index for each time slot is an integer value one greater than the index for the previous time slot. In the illustrated implementation, a type of message can be an actual value, representing a value reported from the client device 202-204, or an average value, which is sent to represent time slots for which the agent 206-208 was offline or not connected to the client device to report aggregate activity during the downtime of the agent. In one implementation, at least a portion of the memory at the agent 206-208 cannot be written to by the end user of the client device 202-204. This portion of the memory can be used to store any data relevant to the contract associated with the client device 202-204, such as the monitored key performance indicators, as well as a last time slot index written by the agent 206-208.

Each agent 206-208 will have some ability to accurately measure the passage of time, even when not active. In one example, the agents 206-208 synchronize with a network time protocol server, although it will be appreciated that other timekeeping options are available for agents that are air gapped or otherwise lack a reliable network connection. When values for the key performance indicators are received from the client device 202-204, the agent 206-208 can compare the current time slot index with the stored last time slot index to determine if one or more time slots have elapsed while the agent was unavailable. Specifically, for a sequential time slot, the current time slot should be one greater than the stored last time slot. When the indices vary by more than one, stored values for the key performance indicators can be subtracted from the currently received values, and the resulting difference can be allocated as an average across the time slots for which the agent 206-208 was inactive. It will be appreciated that the values for the key performance indicators are reported as integers, and thus the average value reported can differ across the time slots where the change in the values for the key performance indicators cannot be evenly divided by the number of time slots. These average values can then be reported to the transaction manager 212 as messages with the “average” type as discussed previously.

It will be appreciated that communication between the agents 206-208 and the transaction manager 212 can be interrupted in some instances. For example, the agent 206-208 may be offline, a wired or wireless network connection for the agent 206-208 could be interrupted, or the client device 202-204 and agent may be air gapped for security reasons. When this occurs, the agents 206-208 can continue to store records representing key performance indicators for their respective client devices 202-204 locally while providing a series of indicators to the user of the client device that connection with the server 210 has been lost or a connection is needed and not available. The indicators can be tiered, with initial indicators being displayed at a terminal associated with the agent 206-208 or the client device 202-204, and later indicators being sent via direct messaging to the user of the client device. Where necessary, the agent 206-208 can publish messages as visual or alphanumeric codes at a display, printer, or other output device that can be used to transmit the message via another device, such as a mobile device. Alternative, a portable external memory device can be used to transfer messages to a computer system that can connect to the server 210. Messages returned from the transaction manager 212 can be provided to the agents 206-208 in a similar manner.

Alternatively or additionally, the transaction manager 212 can detect when a given agent 206-208 has not reported to the transaction manager for a threshold number of time slots. When this occurs, the transaction manager 212 designates the agent 206-208 as offline and generates records at the distributed ledger 220 indicating that the client device 202-204 associated with the agent was offline for those time slots. This continues until communication with the agent 206-208 is restored. At this time, the transaction manager 212 may receive one or more messages from the agent 206-208 representing the time slots for which the client device 202-204 was indicated as being offline. In the illustrated implementation, the transaction manager 212 passes these messages to the distributed ledger 220 as it would any other message.

The distributed ledger 220 can include one or more smart contracts associated with the key performance indicators. In one implementation, the smart contracts can include provisions for compensating the owner of the client devices 202-204 for time slots in which the corresponding agent 206-208 is offline. Alternatively or additionally, the smart contracts, in response to the transaction manager recording a value for the key performance indicator for the client device for a given time slot index, can search the distributed ledger for other entries for the given time slot index and replaces any records in the distributed ledger for the given time slot index for which the client device was indicated as being offline. The contracts can then be executed, for example, by an electronic transfer or a transfer of cryptocurrency from the user of the client device 202-204 to the owner of the client device.

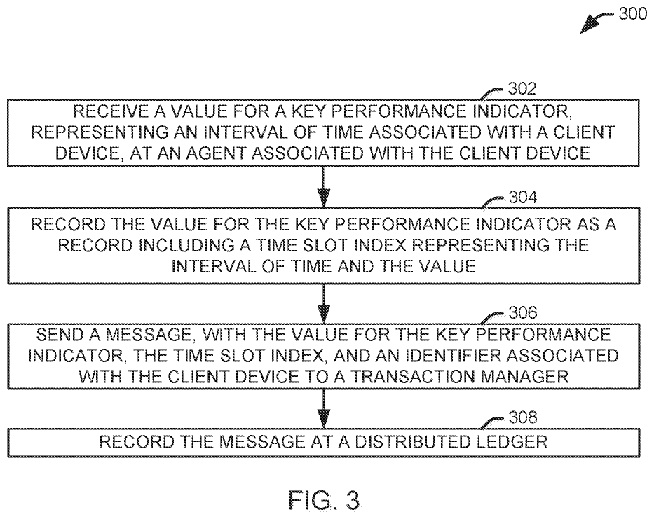

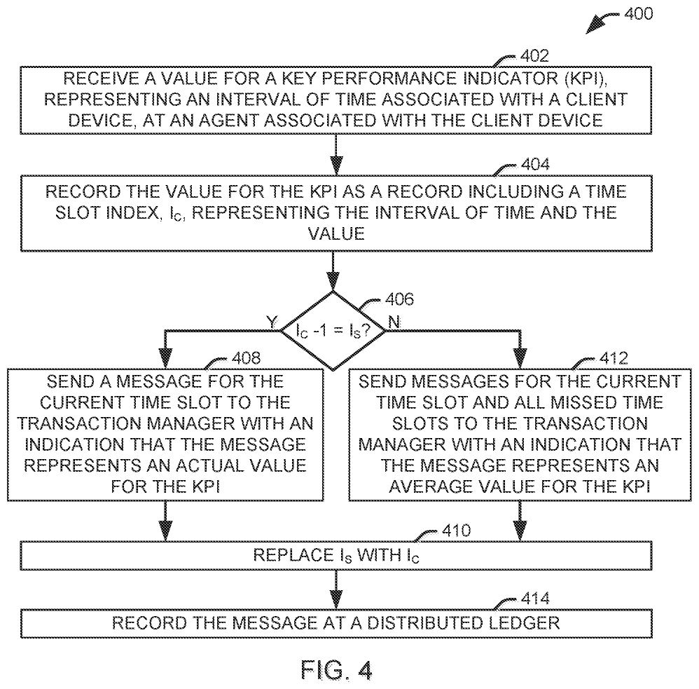

In view of the foregoing structural and functional features described above, example methods will be better appreciated with reference to FIGS. 3 and 4. While, for purposes of simplicity of explanation, the example methods of FIGS. 3 and 4 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method.

FIG. 3 illustrates one example of a method 300 for monitoring the performance of a client device. At 302, a value for a key performance indicator, representing an interval of time associated with a client device, is received at an agent associated with the client device. At 304, the value for the key performance indicator is recorded as a record comprising a time slot index representing the interval of time and the value for the key performance indicator. In one example, the value for the key performance indicator as a record is stored at the agent until the record is sent to an associated transaction manager and a confirmation message associated with the record is received.

At 306, a message, comprising the value for the key performance indicator, the time slot index, and an identifier associated with the client device, is sent to a transaction manager. In one example, sending the message includes generating one of a visual code and an alphanumeric code representing the message at the agent, scanning the code with a device connected to a communications network to provide the message to the device, and transmitting the message from the device to the transaction manager via the communications network. At 308, the message is recorded on a distributed ledger. In one example, a smart contract on the distributed ledger can be executed according to the value for the key performance indicator, such that one of an electronic fund transfer and a transfer of cryptocurrency is made from a user of the client device to an owner of the client device. In one example, commands can be provided from the transaction manager to the agent, and these commands are also recorded on the distributed ledger.

FIG. 4 illustrates another example of a method 400 for monitoring the performance of a client device. At 402, a value is received for a key performance indicator, representing an interval of time associated with a client device, at an agent associated with the client device. At 404, the value for the key performance indicator is recorded as a record comprising a current time slot index representing the interval of time and the value for the key performance indicator. At 406, the current time slot index, I_{C}, is compared to a stored time slot index, I_{S}, representing a time slot for a last value for the key performance indicator received from the client device. It will be appreciated that for a sequential time slot index, if the agent has not been inactive, the value for the current time slot index should be one greater than the stored time slot index.

If the current time slot index is one greater than the stored time slot index (Y), a message, comprising the value for the key performance indicator, the time slot index, an identifier associated with the client device, and an indication that the key performance indicator represents an actual value, is sent to a transaction manager at 408. The method then advances to 410. If the current time slot index is greater than the stored time slot index by more than one (N), it can be assumed that the agent has been offline for some period of time. Accordingly, a current value for the key performance indicator can be compared to a stored value associated with the stored time slot and an average value over a series of time slots for which the agent was inactive can be determined. A set of messages, each comprising an average value for the key performance indicator over a series of time slots that includes the current time slot index, a time slot index representing one of the series of time slots, an identifier associated with the client device, and an indication that the key performance indicator represents an average value, is then sent to the transaction manager at 412. The method then advances to 410, where the stored time slot index is replaced with the current time slot index. The message is recorded on a distributed ledger at 414. It will be appreciated that the decision at 406 can have additional options to handle exceptions due to errors in the allocation and tracking of time slot indices, but these options are not illustrated here in the interest of brevity.

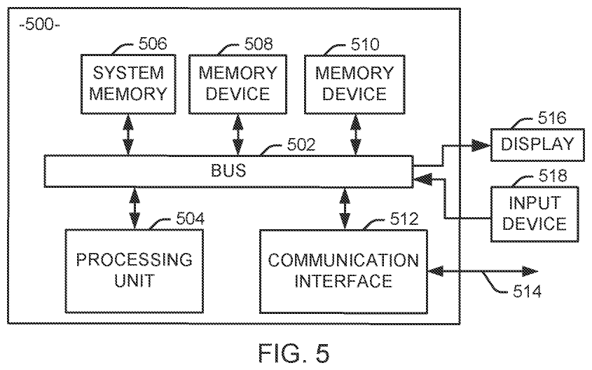

FIG. 5 is a schematic block diagram illustrating an exemplary system 500 of hardware components capable of implementing examples of the systems and methods disclosed herein. The system 500 can include various systems and subsystems. The system 500 can be a personal computer, a laptop computer, a workstation, a computer system, an appliance, an application-specific integrated circuit (ASIC), a server, a server BladeCenter, a server farm, etc.

The system 500 can include a system bus 502, a processing unit 504, a system memory 506, memory devices 508 and 510, a communication interface 512 (e.g., a network interface), a communication link 514, a display 516 (e.g., a video screen), and an input device 518 (e.g., a keyboard, touch screen, and/or a mouse). The system bus 502 can be in communication with the processing unit 504 and the system memory 506. The additional memory devices 508 and 510, such as a hard disk drive, server, standalone database, or other non-volatile memory, can also be in communication with the system bus 502. The system bus 502 interconnects the processing unit 504, the memory devices 506-510, the communication interface 512, the display 516, and the input device 518. In some examples, the system bus 502 also interconnects an additional port (not shown), such as a universal serial bus (USB) port.

The processing unit 504 can be a computing device and can include an application-specific integrated circuit (ASIC). The processing unit 504 executes a set of instructions to implement the operations of examples disclosed herein. The processing unit can include a processing core.

The additional memory devices 506, 508, and 510 can store data, programs, instructions, database queries in text or compiled form, and any other information that may be needed to operate a computer. The memories 506, 508 and 510 can be implemented as computer-readable media (integrated or removable), such as a memory card, disk drive, compact disk (CD), or server accessible over a network. In certain examples, the memories 506, 508 and 510 can comprise text, images, video, and/or audio, portions of which can be available in formats comprehensible to human beings.

Additionally or alternatively, the system 500 can access an external data source or query source through the communication interface 512, which can communicate with the system bus 502 and the communication link 514.

In operation, the system 500 can be used to implement one or more parts of a system in accordance with the present invention. Computer executable logic for implementing the diagnostic system resides on one or more of the system memory 506, and the memory devices 508 and 510 in accordance with certain examples. The processing unit 504 executes one or more computer executable instructions originating from the system memory 506 and the memory devices 508 and 510. The term “computer readable medium” as used herein refers to a medium that participates in providing instructions to the processing unit 504 for execution. This medium may be distributed across multiple discrete assemblies all operatively connected to a common processor or set of related processors.

Specific details are given in the above description to provide a thorough understanding of the embodiments. However, it is understood that the embodiments can be practiced without these specific details. For example, physical components can be shown in block diagrams in order not to obscure the embodiments in unnecessary detail. In other instances, well-known circuits, processes, algorithms, structures, and techniques can be shown without unnecessary detail in order to avoid obscuring the embodiments.

Implementation of the techniques, blocks, steps, and means described above can be done in various ways. For example, these techniques, blocks, steps, and means can be implemented in hardware, software, or a combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments can be described as a process which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed but could have additional steps not included in the figure. A process can correspond to a method, a function, a procedure, a subroutine, a subprogram, etc. When a process corresponds to a function, its termination corresponds to a return of the function to the calling function or the main function.

Furthermore, embodiments can be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks can be stored in a machine-readable medium such as a storage medium. A code segment or machine-executable instruction can represent a procedure, a function, a subprogram, a program, a routine, a subroutine, a module, a software package, a script, a class, or any combination of instructions, data structures, and/or program statements. A code segment can be coupled to another code segment or a hardware circuit by passing and/or receiving information, data, arguments, parameters, and/or memory contents. Information, arguments, parameters, data, etc. can be passed, forwarded, or transmitted via any suitable means including memory sharing, message passing, ticket passing, network transmission, etc.

For a firmware and/or software implementation, the methodologies can be implemented with modules (e.g., procedures, functions, and so on) that perform the functions described herein. Any machine-readable medium tangibly embodying instructions can be used in implementing the methodologies described herein. For example, software codes can be stored in a memory. Memory can be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes but is not limited to portable or fixed storage devices, optical storage devices, wireless channels, and/or various other storage mediums capable of storing that contain or carry instruction(s) and/or data.

In the preceding description, specific details have been set forth in order to provide a thorough understanding of example implementations of the invention described in the disclosure. However, it will be apparent that various implementations may be practiced without these specific details. For example, circuits, systems, networks, processes, and other components may be shown as components in block diagram form in order not to obscure the example implementations in unnecessary detail. In other instances, well-known circuits, processes, algorithms, structures, and techniques may be shown without unnecessary detail in order to avoid obscuring the examples. The description of the example implementations will provide those skilled in the art with an enabling description for implementing an example of the invention, but it should be understood that various changes may be made in the function and arrangement of elements without departing from the spirit and scope of the invention. Accordingly, the present invention is intended to embrace all such alterations, modifications, and variations that fall within the scope of the appended claims.

What is claimed is:

1. A system comprising:
an agent configured to monitor a dynamic, user-defined set of key performance indicators by periodically polling a client device and generate messages including an aggregate value for a key performance indicator over a predefined period of time, and an identifier associated with the client device;
a transaction manager that accepts messages from the agent, provides a confirmation message to the agent indicating receipt of each message, and records the messages in a distributed ledger; and
the distributed ledger.

2. The system of claim 1, the system comprising a user interface that allows a user to provide the set of commands for the agent, the transaction manager communicating the commands to the agent in response to accepting a message from the agent and recording a record representing each command of the set of commands in the distributed ledger.

3. The system of claim 1, the distributed ledger includes a smart contract associated with the key performance indicator, the smart contract, in response to the transaction manager recording a value for the key performance indicator for the client device initiates one of an electronic fund transfer and a transfer of cryptocurrency is made from a user of the client device to an owner of the client device having an amount based on the value for the key performance indicator.

4. The system of claim 1, wherein the agent stores messages locally until the confirmation message is received.

5. The system of claim 4, wherein the agent generates messages periodically at a first interval until a predetermined storage limit is achieved, and generates messages periodically at a second interval after the predetermined storage limit is achieved, the agent generating respective representative values of the key performance indicator for subsets of a first set of messages generated periodically at the first interval, each representative parameter representing the key performance indicator for a time period equal to the second interval.

6. The system of claim 1, wherein the agent generates a hash value for each message that can be used at the transaction manager to verify that the contents of the message have not been modified.

7. The system of claim 1, wherein the agent communicates the message via one of a visual code and an alphanumeric code that is scanned by a device connected to a communications network.

8. The system of claim 1, wherein the agent records the key performance indicator from the client machine as a record comprising a time slot index, representing an interval of time, and a value for the key performance indicator associated with the client device during that time interval, wherein the record representing each time slot index is provided from the agent to the transaction manager as a message.

9. The system of claim 8, the agent storing a record representing a most recent time slot index in a portion of a memory that is not writable by an end user of the client device.

10. The system of claim 8, wherein the agent compares a record associated with a current state of the client device to the stored record representing the most recent time slot index to determine if the client device has been active while the agent was inactive.

11. The system of claim 10, wherein the agent generates a message for each of a set of time slot indices for which the agent was inactive during the intervals of time represented by the set of time slot indices, the message comprising an average value for the key performance indicator over the intervals of time represented by the set of time slot indices and an indication that the values for the key performance indicator are averaged values.

12. The system of claim 8, wherein the transaction manager, in response to the passage of a threshold period of time in which no communication is received from the agent, records a record in the distributed ledger for each of a plurality of time slot indices representing the threshold period of time, each record indicating that the client device is offline.

13. The system of 12, wherein the distributed ledger includes a smart contract associated with the key performance indicator, the smart contract, in response to the transaction manager recording a value for the key performance indicator for the client device for a given time slot index, searches the distributed ledger for other entries for the given time slot index and replaces any records in the distributed ledger for the given time slot index for which the client device was indicated as being offline.

14. A method comprising:
receiving a value for a key performance indicator, representing an interval of time associated with a client device, at an agent associated with the client device;
recording the value for the key performance indicator as a record comprising a time slot index representing the interval of time and the value for the key performance indicator;
sending a message, comprising the value for the key performance indicator, the time slot index, and an identifier associated with the client device, to a transaction manager; and
recording the message on a distributed ledger.

15. The method of claim 14, wherein recording the value for the key performance indicator as a record comprises storing the value for the value for the key performance indicator at the agent until a confirmation message associated with the record is received from the transaction manager.

16. The method of claim 14, further comprising:
providing a command from the transaction manager to the agent; and
recording the command on the distributed ledger.

17. The method of claim 14, further comprising:
storing a record representing a most recent time slot index in a portion of a memory that is not writable by an end user of the client device; and
comparing a record associated with a current state of the client device to the stored record to determine if the client device has been active while the agent was inactive.

18. The method of claim 14, wherein sending the message comprises:
generating one of a visual code and an alphanumeric code representing the message at the agent;
scanning the one of the visual code and the alphanumeric code with a device connected to a communications network to provide the message to the device; and
transmitting the message from the device to the transaction manager via the communications network.

19. The method of claim 14, further comprising executing a smart contract on the distributed ledger according to the value for the key performance indicator, such that one of an electronic fund transfer and a transfer of cryptocurrency is made from a user of the client device to an owner of the client device.

20. A method comprising:
receiving a value for a key performance indicator, representing an interval of time associated with a client device, at an agent associated with the client device;
recording the value for the key performance indicator as a record comprising a current time slot index representing the interval of time and the value for the key performance indicator;
comparing the current time slot index to a stored time slot index representing a time slot for a last value for the key performance indicator received from the client device;
sending a message, comprising the value for the key performance indicator, the time slot index, an identifier associated with the client device, and an indication that the key performance indicator represents an actual value, to a transaction manager if the current time slot index has a value greater than the stored time slot index by one;
sending a set of messages, each comprising an average value for the key performance indicator over a series of time slots that includes the current time slot index, a time slot index representing one of the series of time slots, an identifier associated with the client device, and an indication that the key performance indicator represents an average value, to the transaction manager if the current time slot index has a value greater than the stored time slot index by more than one;
replacing the stored time slot index with the current time slot index; and
recording the message on a distributed ledger.
